(19) United States
(12) Patent Application Publication
(10) Pub. No.: US 2009/0265444 A1
(43) Pub. Date: Oct. 22, 2009

(54) MAINTAINING CORPORATE IDENTITY IN SYNDICATED CONTENT

(76) Inventors: Amy Herrman Dewar, Durham, NC (US); Robert Charles Leah, Carry, NC (US); Peter Chi-Shing Yim, Raleigh, NC (US); Nicholas Edward Poore, Durham, NC (US)

Correspondence Address: HOLLAND & KNIGHT LLP, 10 ST. JAMES AVENUE, BOSTON, MA, 02116, US

(21) Appl. No.: 12/103,756

(22) Filed: Apr. 16, 2008

(51) Int. Cl. G06F 15/173

(52) U.S. Cl. 709/218

(57) ABSTRACT

User selected content and content provider defined content may be received by a web widget. The user defined content and the content provider defined content may be provided via a third party web site.

### BACKGROUND OF THE INVENTION

The present disclosure relates to syndicated web content, and more particularly to maintaining corporate identity in syndicated web content.

Aggregate/mash-up websites and start pages, such as iGoogle and Netvibes, (e.g., syndication websites), allow the aggregation of content from various syndication content providers. Often such aggregate/mash-up websites utilize web feeds, gadgets/widgets and the like to allow content from various websites to be consumed on a single webpage. For example, using an aggregate/mash-up start page, a user may view recent news items (e.g., headlines or article clips) from various sources, local weather forecasts, recent blog entries from selected weblogs, and the like (i.e., syndicated content), all on a single webpage. Typically, the content, or types of content are user selectable, allowing the user to display content that the user deems of interest.

Aggregate/mash-up sites allow users to easily consume content from various websites, providing a convenient resource for users, and the ability for content providers to achieve increased distribution of provided content. However, as content is increasingly consumed via syndication websites, the individual content providers lose the direct relationship with the users consuming the content. The content providers thus sacrifice the opportunity to promote services and products. Ultimately, the loss of a direct relationship with users may result in a loss of revenue for the content providers, as the ability to market and promote services and products directly to users is eroded.

### BRIEF SUMMARY OF THE INVENTION

According to a first implementation, a method includes receiving user selected content, and receiving content provider defined content. The user defined content and the content provider defined content are provided via a third party web site.

According to a second implementation, a computer program product includes a computer readable medium having a plurality of instructions stored on it. When executed by a processor, the instructions cause the processor to perform operations including receiving user selected content, and receiving content provider defined content. The user defined content and the content provider defined content are provided via a third party web site.

One or more of the following features may be included. The third party web site may include a web based aggregator. Receiving user selected content may include receiving content transmitted by a content provider based upon, at least in part, one or more user selections. The user selected content may include a web feed.

Receiving content provider defined content may include receiving content transmitted by a content provider. The content provider defined content may include one or more of branding information and marketing information. The content provider defined content may include scrolling text. The content provider defined content may include an expandable selection menu. The expandable selection menu may include one or more hyperlinks.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a schematic view of a syndication process coupled to a distributed computing network.

FIG. 2 is a flow chart of a process that may be executed by the syndication process of FIG. 1.

FIG. 3 is a diagrammatic view of a display screen rendered by the syndication process and/or a client application of FIG. 1.

FIG. 4 is a diagrammatic view of a display screen rendered by the syndication process and/or a client application of FIG. 1.

FIG. 5 is a diagrammatic view of a display screen rendered by the syndication process and/or a client application of FIG. 1.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

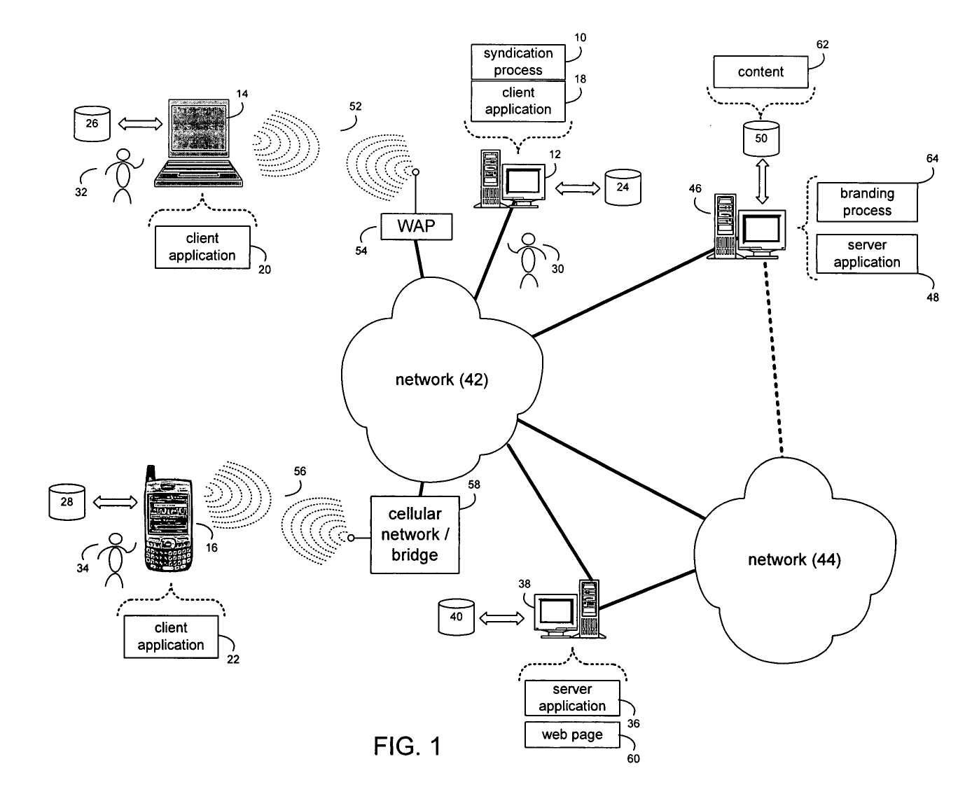

Referring to FIG. 1, there is shown syndication process 10 that may be executed by a client electronic device, (e.g., client electronic devices 12, 14, 16). As will be discussed in greater detail below, syndication process 10 may receive user selected content, and receive content provider defined content. The user selected content and the content provider defined content may be provided via a third party web site.

Syndication process 10 may include, for example, a web widget, gadget or the like, which may be embedded within a page of HTML (HyperText Mark-up Language), i.e., a web page. The client electronic device (e.g., client electronic devices 12, 14, 16) may also execute a client application (e.g., client applications 18, 20, 22), which may include a web browsing application, such as Microsoft Internet Explorer™ and Netscape Navigator™ that are capable of loading and displaying web pages. Syndication process 10 may be executed within the environment of client application 18 (and/or one or more of client applications 20, 22). The instruction sets and subroutines of client applications, 18, 20, 22, which may be stored on storage devices 24, 26, 28, may be executed by one or more processors (not shown) and one or more memory architectures (not shown) included within client electronic devices 12, 14, 16. Storage devices 24, 26, 28 may include, but are not limited to: hard disk drives, tape drives, optical drives, RAID arrays, random access memories (RAM), read only memories (ROM), solid state drives and storage devices (e.g., flash memory sticks, compact flash storage devices, secure digital storage devices, and the like). Examples of client electronic devices 12, 14, 16 may include, but are not limited to, personal computer 12, laptop computer 14, personal digital assistant 16, a data-enabled, cellular telephone (not shown), and a dedicated network device (not shown), for example. Using client applications 18, 20, 22, users 30, 32, 34 may access a web server application (e.g., server application 36 executed by server computer 38) and may allow users to e.g., load and view web pages, e.g., which may include syndication process 10.

As mentioned, the instruction sets and subroutines of syndication process 10 may be embedded within a web page (e.g., which may be stored in storage device 40 of server computer 38). When the web page including syndication process 10 is loaded, e.g., via one or more of client applications 18, 20, 22, the instruction sets and subroutines of syndication process 10 may, at least temporarily, reside on one or more of client electronic devices 12, 14, 16 (e.g., within a memory cache (not shown) or on one or more of storage devices 24, 26, 28). Additionally/alternatively, the instruction sets and subroutines of syndication process 10 may persistently reside on one or more of storage devices 24, 26, 28. The instruction sets and subroutines of syndication process 10 may be executed by one or more processor (not shown) and one or more memory architectures (not shown) included within client electronic devices 12, 14, 16.

The instruction sets and subroutines of server application 36, which may be stored on storage device 40 coupled to server computer 38, may be executed by one or more processors (not shown) and one or more memory architectures (not shown) incorporated within server computer 38. Examples of a web server application (e.g., server application 36) may include but are not limited to: Microsoft IIS, Novell Webserver, or Apache Webserver, that allows for HTTP (i.e., HyperText Transfer Protocol) access to server computer 38 via network 42. Network 42 may be connected to one or more secondary networks (e.g., network 44), examples of which may include but are not limited to: a local area network; a wide area network; or an intranet, for example. Storage device 40 may include but is not limited to: a hard disk drive; a tape drive; an optical drive; a RAID array; a random access memory (RAM); and a read-only memory (ROM).

Examples of server computer 38 may include, but are not limited to: a personal computer, a server computer, a series of server computers, a mini computer, and a mainframe computer. Server computer 38 may be a web server (or a series of servers) running a network operating system, examples of which may include but are not limited to: Microsoft® Windows® XP Server; Novell® NetWare®; or Redhat® Linux®, for example (Microsoft and Windows are registered trademarks of Microsoft Corporation in the United States, other countries or both; Novell and NetWare are registered trademarks of Novell Corporation in the United States, other countries or both; Redhat is a registered trademark of RedHat Corporation in the United States, other countries or both; and Linux is a registered trademark of Linus Torvales in the United States, other countries or both), for example.

Users 30, 32, 34 may access server application 36 directly through the device on which the client application (e.g., client applications 18, 20, 22) is executed, namely client electronic devices 12, 14, 16, for example. Users 30, 32, 34 may access server application 36 directly through network 42 or through secondary network 44. Users 30, 32, 34 may access server application 36, e.g., to load and view web pages. At least a portion of the content of the web pages may be stored on storage device 40, coupled to server computer 38. Further, as in the case of aggregate/mash-up (i.e., syndication) web pages, at least a portion of the content of the webpage may be provided by one or more content providers, e.g., via content provider server computer 46.

Content provider server computer 46 may include, but is not limited to: a personal computer, a server computer, a series of server computers, a mini computer, and a mainframe computer. Content provider server computer 46 may be a web server (or a series of servers) running a network operating system, examples of which may include but are not limited to: Microsoft® Windows® XP Server; Novell® NetWare®; or Redhat® Linux®, for example (Microsoft and Windows are registered trademarks of Microsoft Corporation in the United States, other countries or both; Novell and NetWare are registered trademarks of Novell Corporation in the United States, other countries or both; Redhat is a registered trademark of RedHat Corporation in the United States, other countries or both; and Linux is a registered trademark of Linus Torvales in the United States, other countries or both), for example.

Content provider server computer 46 may execute a web server application (e.g., server application 48), examples of which may include but are not limited to: Microsoft IIS, Novell Webserver, or Apache Webserver, that allows for HTTP (i.e., HyperText Transfer Protocol) access to content provider server computer 46 via network 42. Content provider server computer 46 may be connected (as shown by broken line) to one or more secondary networks (e.g., network 44). The instruction sets and subroutines of server application 48, which may be stored on storage device 50 coupled to content provider server computer 46, may be executed by one or more processors (not shown) and one or more memory architectures (not shown) incorporated within content provider server computer 46. Examples of Storage device 50 may include but is not limited to: a hard disk drive; a tape drive; an optical drive; a RAID array; a random access memory (RAM); and a read-only memory (ROM).

The various client electronic devices may be directly or indirectly coupled to network 42 (or network 44). For example, personal computer 12 is shown directly coupled to network 42 via a hardwired network connection. Laptop computer 14 is shown wirelessly coupled to network 44 via wireless communication channel 52 established between laptop computer 14 and wireless access point (i.e., WAP) 54, which is shown directly coupled to network 44. WAP 54 may be, for example, an IEEE 802.11a, 802.11b, 802.11g, Wi-Fi, and/or Bluetooth device that is capable of establishing wireless communication channel 52 between laptop computer 14 and WAP 54. Personal digital assistant 16 is shown wirelessly coupled to network 44 via wireless communication channel 56 established between personal digital assistant 16 and cellular network/bridge 58, which is shown directly coupled to network 44.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 12, 14, 16 may each execute an operating system, examples of which may include but are not limited to Microsoft Windows™, Microsoft Windows CE™, Redhat Linux™, or a custom operating system.

For the purpose of the following description, client application 18 is going to be described for illustrative purposes. However, this is not intended to be a limitation of this disclosure, as other client applications (e.g., client applications 20, 22) may be equally utilized.

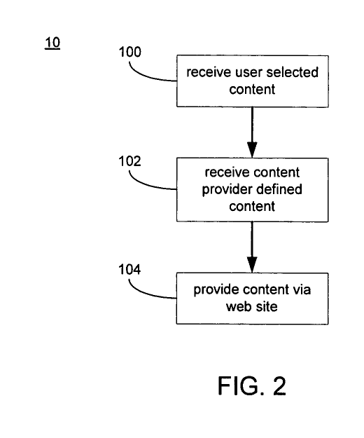

Referring also to FIG. 2, syndication process 10 may receive 100 user selected content, and may receive 102 content provider defined content. The user selected content and the content provider defined content may be provided 104 via a third party website.

Continuing with the above-stated example, user 30 may access aggregate/mash-up web page 60 (e.g., which may provide syndicated content) using client application 18. Web page 60 may be stored on storage device 40 of server computer 38, and may be downloaded using client application 18 and may be rendered on client electronic device 12. Syndication process 10 may be embedded within web page 60, such that when web page 60 is downloaded, syndication process 10 may be executed by client electronic device 12. In part, syndication process 10 may allow syndicated web content, as well as other web content, embodied in web page 60 to be consumed by user 30.

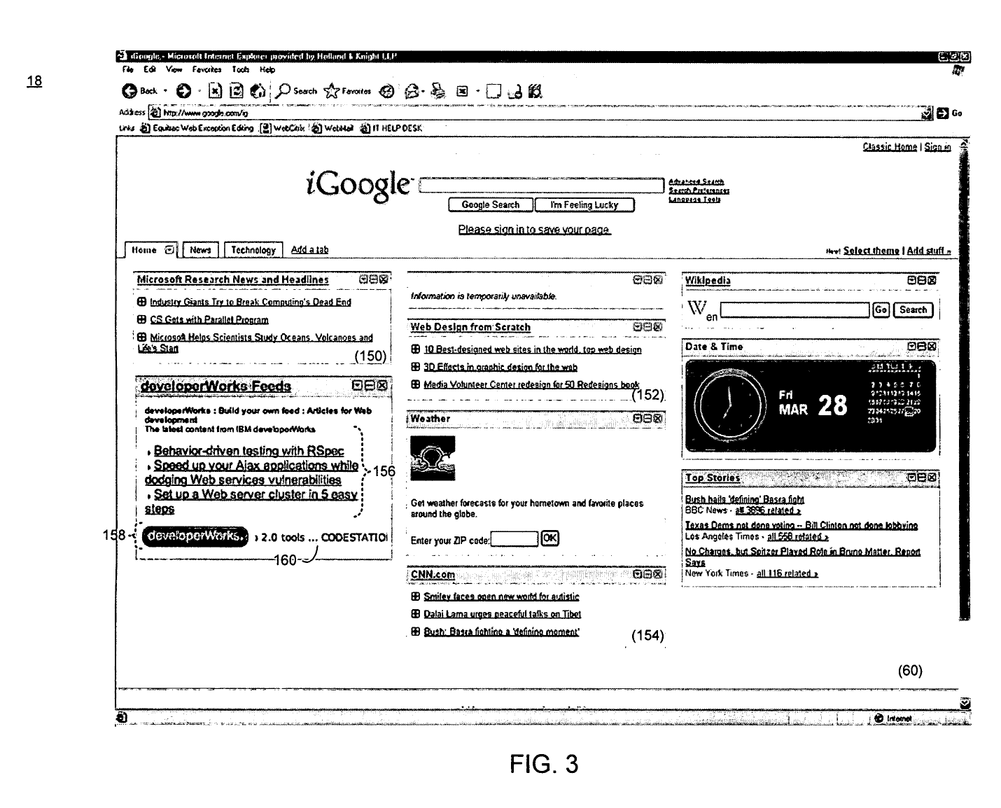

Continuing with the above-stated example, and referring also to FIG. 3, web page 60 may be a web based aggregator in the form of a start page (e.g., an iGoogle start page, as shown, a Netvibes start page, or the like). However, web page 60 may include various other aggregate/mash-up web pages. Client application 18, alone or in conjunction with syndication process 10, may allow user 30 to consume web page 60, including various pieces of syndicated and/or non-syndicated content (e.g., 150, 152, 154, for example), which may be provided via one or more web widgets.

As shown, syndication process 10 and/or client application 18 may provide 104 user selected content 156, associated with a given content provider, via web page 60. Providing 104 user selected content 156 may include receiving 100 user selected content from a content provider (e.g., via content provider server application 48). Receiving 100 user selected content may include receiving 100 content transmitted by a content provider (e.g., via content provider server application 48) based upon, at least in part, one or more user selections. For example, user 30 may visit a web site (not shown) and may select to receive content (e.g., content 62 stored on storage device 50), for example, a web feed (e.g., an RSS web feed) of recent articles provided by the content provider. In subscribing to the web feed, user 30 may select, at least in a general nature and/or among various options, content to be received from the content provider. User 30 may export syndication process 10 to web page 60 (e.g., which may be a start page, or the like), for example resulting in syndication process 10 being embedded within web page 60. Based upon, at least in part, user 30's selection of content, syndication process 10 may receive 100 user selected content 156 when executed within the environment of client application 18.

Receiving 102 content provider defined content may include receiving content transmitted by a content provider. For example, branding process 64, which may be executed by content provider server computer 46, may transmit content provider defined content to syndication process 10, e.g., via asynchronous javascript or other suitable mechanism. The content provider defined content may include, for example, one or more of branding information and marketing information. For example, syndication process 10 may provide 104 content provider defined information 158 via web page 60. The content provider defined information 158 may include marketing information, e.g., relating to products, services, and the like, provided by the content provider. Additionally, content provider defined information 158 may include branding information, or other promotional content. The content provider defined content may include dynamic content, which may be changed and/or updated by the content provider. As such, the content provider may periodically, continuously, etc., change the content that is transmitted to, and received 102, by syndication process 10. The content provider defined content may reside on storage device 50 (e.g., included within content 62).

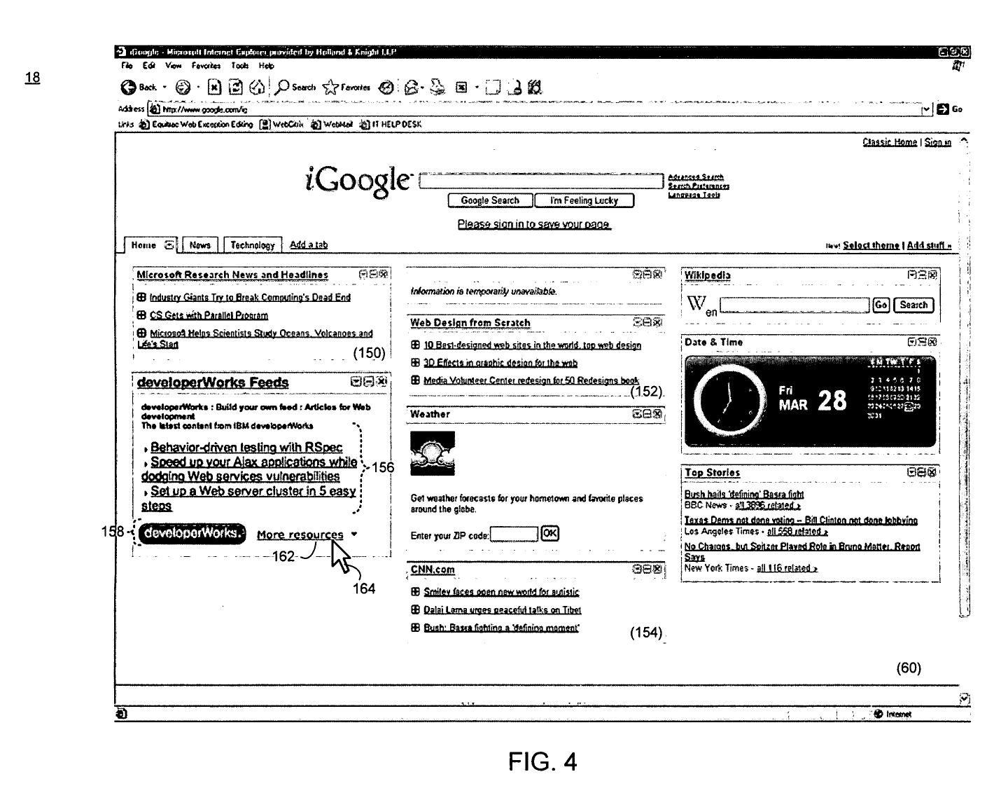

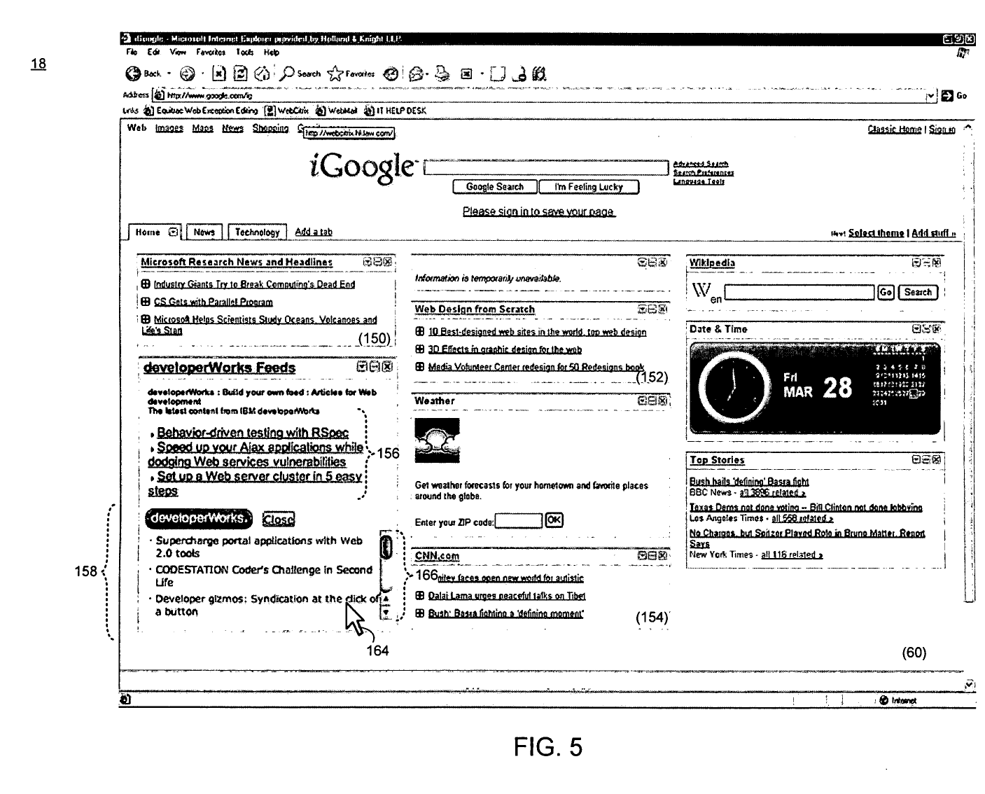

The content provider defined content may include scrolling text. For example, as shown in FIG. 3, syndication process 10 may provide at least a portion of content provider defined content 158 as scrolling text 160. Further, and referring also to FIGS. 4 and 5, the content provider defined content may include an expandable selection menu. For example, as shown content provider defined content 158 may include “More resources” option 162. User 30 may select, via onscreen pointer 164 (e.g., which may be controlled by a pointing device, such as a mouse; not shown), “More resources” option 162. Selecting, via onscreen pointer 164, “More resources” option 162 may result in syndication process 10 providing 104 expandable selection menu 166 of content provider defined content. The expandable selection menu may include one or more hyperlinks. For example, user 30 may select one or more of the items contained within expandable selection menu 166, resulting in a corresponding web page being retrieved by client application 18. The corresponding web page may reside on storage device 50 (e.g., may be contained within content 62), and may be retrieved via content provider server application 48.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method comprising:
receiving user selected content;
receiving content provider defined content; and
providing the user defined content and the content provider defined content via a third party web site.

2. The method of claim 1, wherein receiving user selected content includes receiving content transmitted by a content provider based upon, at least in part, one or more user selections.

3. The method of claim 2, wherein the user selected content includes a web feed.

4. The method of claim 1, wherein receiving content provider defined content includes receiving content transmitted by a content provider.

5. The method of claim 4, wherein the content provider defined content includes one or more of branding information and marketing information.

6. The method of claim 1, wherein the content provider defined content includes scrolling text.

7. The method of claim 1, wherein the content provider defined content includes an expandable selection menu.

8. The method of claim 7, wherein the expandable selection menu includes one or more hyperlinks.

9. The method of claim 1, wherein the third party web site includes a web based aggregator.

10. A computer program product comprising a computer readable medium having a plurality of instructions stored thereon, which, when executed by a processor, cause the processor to perform operations including:
receiving user selected content;
receiving content provider defined content; and
providing the user defined content and the content provider defined content via a third party web site.

11. The computer program product of claim 10, wherein the instructions for receiving user selected content include instructions for receiving content transmitted by a content provider based upon, at least in part, one or more user selections.

12. The computer program product of claim 11, wherein the user selected content includes a web feed.

13. The computer program product of claim 10, wherein the instructions for receiving content provider defined content include instructions for receiving content transmitted by a content provider.

14. The computer program product of claim 13, wherein the content provider defined content includes one or more of branding information and marketing information.

15. The computer program product of claim 10, wherein the content provider defined content includes scrolling text.

16. The computer program product of claim 10, wherein the content provider defined content includes an expandable selection menu.

17. The computer program product of claim 16, wherein the expandable selection menu includes one or more hyperlinks.

18. The computer program product of claim 10, wherein the third party web site includes a web based aggregator.
